(19) United States
(12) Patent Application Publication
(10) Pub. No.: US 2018/0195625 A1
(43) Pub. Date: Jul. 12, 2018

(54) BALL VALVE DEVICE

(71) Applicant: Chieh-An HUNG, Taichung (TW)

(72) Inventor: Chieh-An HUNG, Taichung (TW)

(21) Appl. No.: 15/838,707

(22) Filed: Dec. 12, 2017

(30) Foreign Application Priority Data
Jan. 6, 2017 (TW) 106200295

(51) Int. Cl. F16K 5/06; F16K 27/06; F16K 31/60

(52) U.S. Cl. CPC F16K 5/0626; F16K 31/602; F16K 27/067; F16K 5/0605

(57) ABSTRACT

A ball valve device contains: a body and a hollow threaded tube. The body includes an operation handle, a chamber opened/closed by the operation handle, an outlet formed on a first end of the body and communicating with the chamber, a connection portion formed on a second end of the body and communicating with the chamber, at least one protrusion extending outward from the connection portion, and a connector connecting and communicating with the connection portion. The threaded tube includes a fitting portion formed on a first end of the threaded tube and fitted on the connection portion, a threaded section arranged on a second end of the threaded tube, and at least one recess corresponding to the at least one protrusion, wherein the connector is fitted in the threaded tube, and the at least one protrusion retains in the at least one recess of the body.

### FIELD OF THE INVENTION

The present invention relates to a ball valve device which is applicable for construction hardware field and is replaced easily.

### BACKGROUND OF THE INVENTION

A conventional ball valve is connected with a water pipe which is coupled in a building so as to turn on/off water.

With reference to FIGS. 1-2, two conventional ball valve devices are housed in an accommodation box 51 of a wooden frame 50 in a building, wherein each of the two ball valve devices 60 has a threaded tube 61 formed on a first end thereof, and each ball valve device 60 has an outlet 62 defined on a second end thereof and connecting to an outlet pipe 53. As connecting each ball valve device 60, it is screwed with an inlet pipe 52 in a wall of the building by way of the threaded tube 61, and a lid (not shown) covers the accommodation box 51 so as to enhance aesthetics appearance.

When each ball valve device 60 is broken, it is unscrewed with the inlet pipe 52. The threaded tube 61 of each ball valve device 60 is in connection with the inlet pipe 52 in the wall of the building, hence the wall is hit so as to replace the accommodation box (in which each ball valve device 60 is housed) when water leaks from each ball valve device 60. Accordingly, the building and the inlet pipe are broken as replacing each ball valve device.

The present invention has arisen to mitigate and/or obviate the afore-described disadvantages.

### SUMMARY OF THE INVENTION

The primary aspect of the present invention is to provide a ball valve device which is connected and removed easily so as to reduce replacement cost and to obtain recycle purpose.

To obtain the above aspect, a ball valve device provided by the present invention contains: a body and a threaded tube.

The body includes an operation handle, a chamber defined in the body and being opened/closed by the operation handle, an outlet formed on a first end of the body and communicating with the chamber, a connection portion formed on a second end of the body and communicating with the chamber, and at least one protrusion extending outward from a peripheral side of the connection portion, and a connector connecting and communicating with the connection portion.

The threaded tube is hollow, and the threaded tube includes a fitting portion formed on a first end of the threaded tube which faces the body and fitted on the connection portion of the body, a threaded section arranged on a second end of the threaded tube, and at least one recess corresponding to the at least one protrusion, wherein the connector is fitted in the threaded tube, and the at least one protrusion retains in the at least one recess of the body.

Preferably, two protrusions extend outward from the body and are opposite to each other, and the fitting portion of the threaded tube includes two recesses retaining with the two protrusions individually.

Preferably, the body further includes a positioning groove defined on the peripheral side of the connection portion adjacent to the at least one protrusion, the threaded tube further includes a screwing orifice corresponding to the positioning groove of the connection portion, and a lamination element is screwed in the positioning groove of the body via the screwing orifice of the threaded tube so as to fix the threaded tube and the body.

Preferably, the connector of the body has at least one surrounding trough arranged on an outer wall thereof, and the ball valve device further comprises at least one O ring fitted in the at least one surrounding trough of the body, wherein the at least one O ring abuts against the at least one surrounding trough of the connector and the threaded tube.

Preferably, the connector of the body has three surrounding troughs arranged on an outer wall thereof, and the ball valve device further comprises three O rings fitted in the three surrounding troughs of the body respectively, wherein the three O rings respectively abut against the three surrounding troughs of the connector and the threaded tube.

Preferably, the at least one recess of the threaded tube is in an L shape, and the at least one recess has an opening defined on one end thereof and facing the chamber of the body so that the at least one protrusion moves to and horizontally retains in the at least one L-shaped recess via the opening.

### BRIEF DESCRIPTION OF THE DRAWINGS

FIG. 1 is a perspective view of a conventional ball valve device.

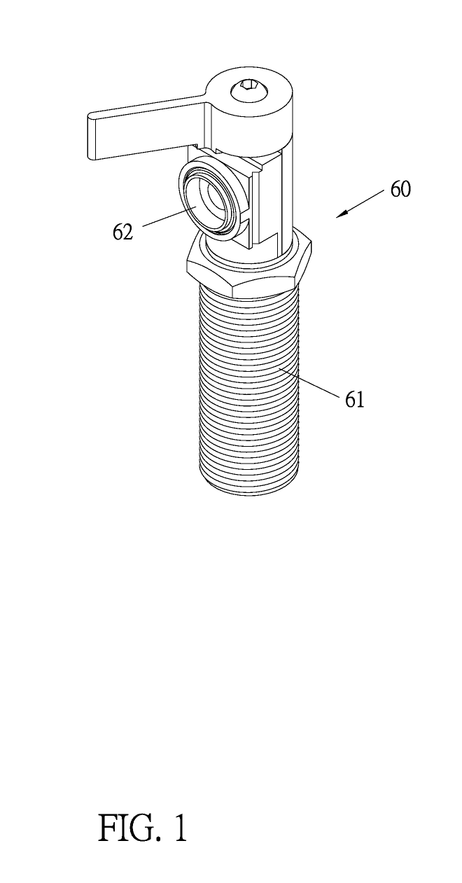

FIG. 2 is a perspective view showing the application of the conventional ball valve device.

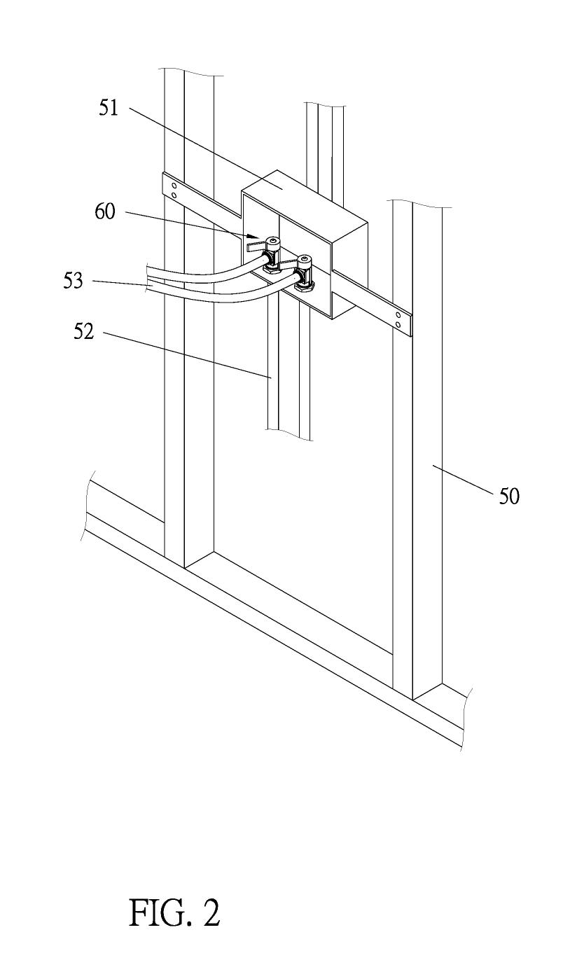

FIG. 3 is a perspective view showing the assembly of a ball valve device according to a preferred embodiment of the present invention.

FIG. 4 is a perspective view showing the exploded components of the ball valve device according to the preferred embodiment of the present invention.

FIG. 5 is a perspective view showing the application of the ball valve device according to the preferred embodiment of the present invention.

FIG. 6 is a perspective view showing the operation of the ball valve device according to the preferred embodiment of the present invention.

FIG. 7 is another perspective view showing the operation of the ball valve device according to the preferred embodiment of the present invention.

FIG. 8 is also another perspective view showing the operation of the ball valve device according to the preferred embodiment of the present invention.

### DETAILED DESCRIPTION OF THE PREFERRED EMBODIMENTS

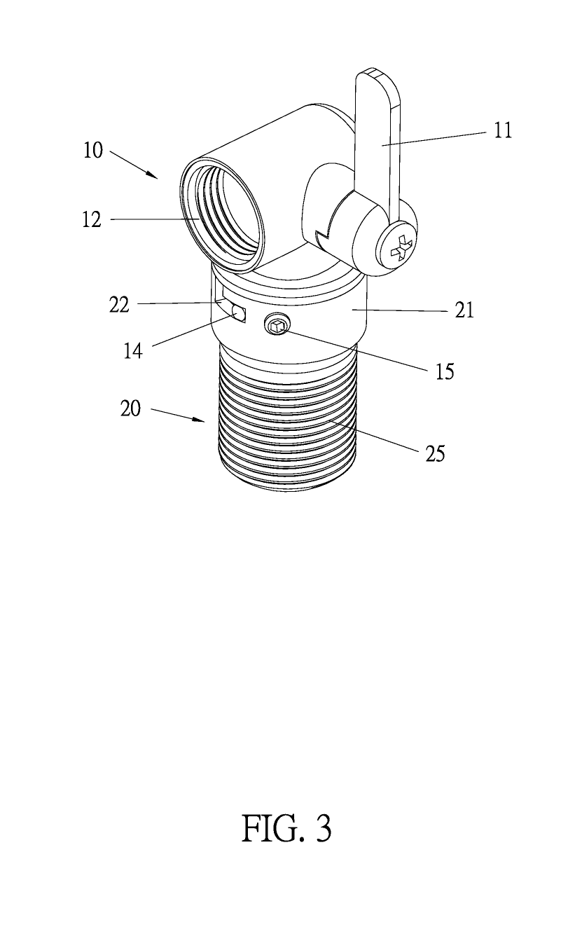

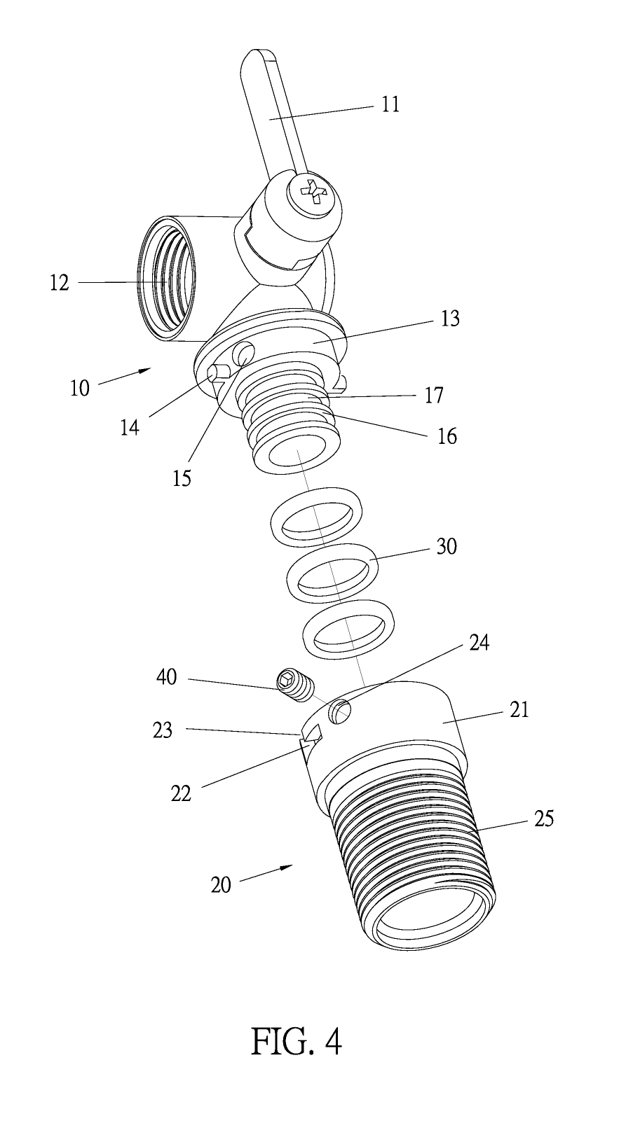

With reference to FIGS. 3-4, a ball valve device according to a preferred embodiment of the present invention comprises: a body 10, a threaded tube 20, and at least one O ring 30.

The body 10 includes an operation handle 11, a chamber (not shown) defined in the body 10 and being opened/closed by the operation handle 11, an outlet 12 formed on a first end of the body 10 and being opened/closed so as to flow/stop water, a connection portion 13 formed on a second end of the body 10 and communicating with the chamber (not shown), and at least one protrusion 14 extending outward from a peripheral side of the connection portion 13. In this embodiment, two protrusions 14 extend outward from the peripheral side of the connection portion 13 are opposite to each other. The body 10 further includes a positioning groove 15 defined on the peripheral side of the connection portion 13 adjacent to the two protrusion 14, a connector 16 connecting and communicating with the connection portion 13, and at least one surrounding trough 17 arranged on an outer wall of the connector 16. In this embodiment, three surrounding troughs 17 are arranged on the outer wall of the connector 16.

The at least one O ring 30 is fitted in the at least one surrounding trough 17 of the body 10. In this embodiment, three O rings 30 are fitted on the three surrounding troughs 17 of the body 10 respectively.

The threaded tube 20 is hollow, and the threaded tube 20 includes a fitting portion 21 formed on a first end of the threaded tube 20 which faces the body 10 and fitted on the connection portion 13 of the body 10, a threaded section 25 arranged on a second end of the threaded tube 20, two L-shaped recesses 22 corresponding to the two protrusions 14 individually, and two openings 23 defined on the two L-shaped recesses 22 respectively and facing the chamber of the body 10 so that the two protrusions 14 move to and horizontally retain in the two L-shaped recesses 22 via the two openings 23 individually, wherein the three O rings 30 abut against the three surrounding troughs 17 of the connector 16 and the fitting portion 21 so as to avoid water leakage. The threaded tube 20 further includes a screwing orifice 24 corresponding to the positioning groove 15 of the connection portion 13 of the body 10, and a lamination element 40 is screwed in the positioning groove 15 of the body 10 via the screwing orifice 24 of the threaded tube 20 so as to fix the threaded tube 20 and the body 10.

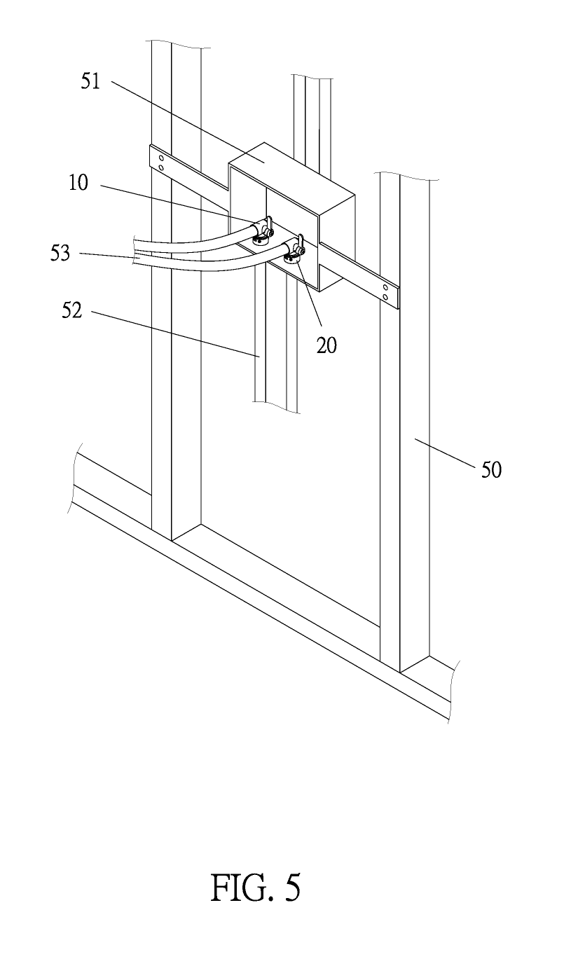

Referring to FIGS. 3-5, in application, an accommodation box 51 is mounted on a wooden frame 50, the body 10 is locked with the threaded tube 20, and the ball valve device is accommodated in the accommodation box 51. As shown in FIG. 5, the accommodation box 51 houses two sets of ball valve devices. Alternatively, one set of ball valve device or at least three sets of ball valve devices are housed in the accommodation box 51, wherein two threaded sections 25 of two threaded tubes 20 are screwed in two inlet pipes 52 respectively, and two outlets 12 of two bodies 10 are coupled with two outlet pipes 53 individually, thus connecting two ball valve devices.

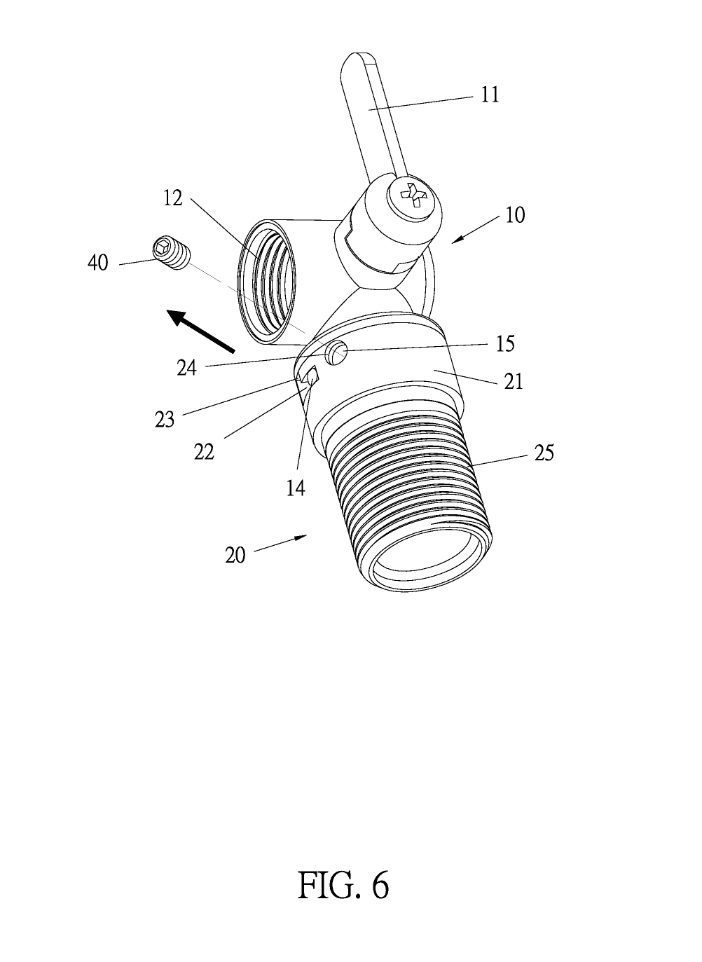

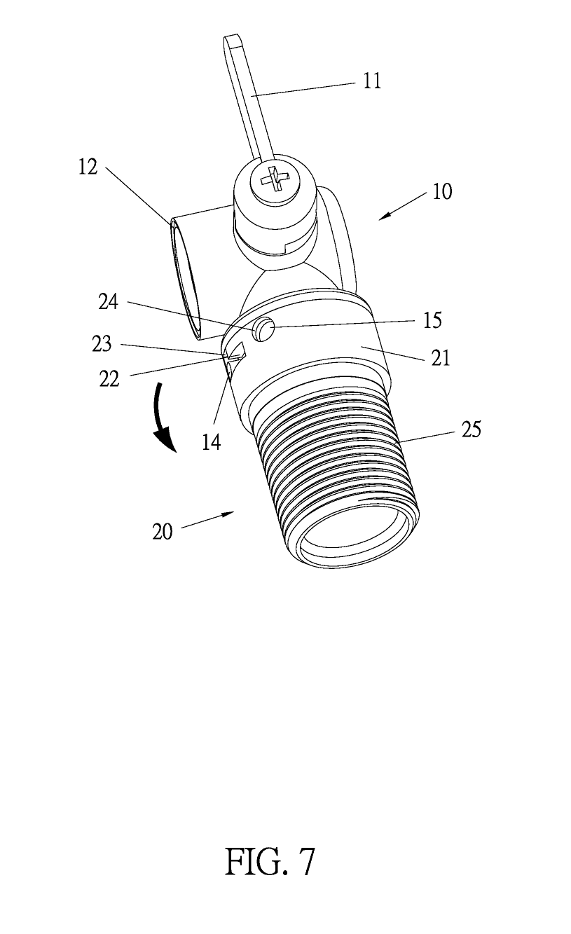

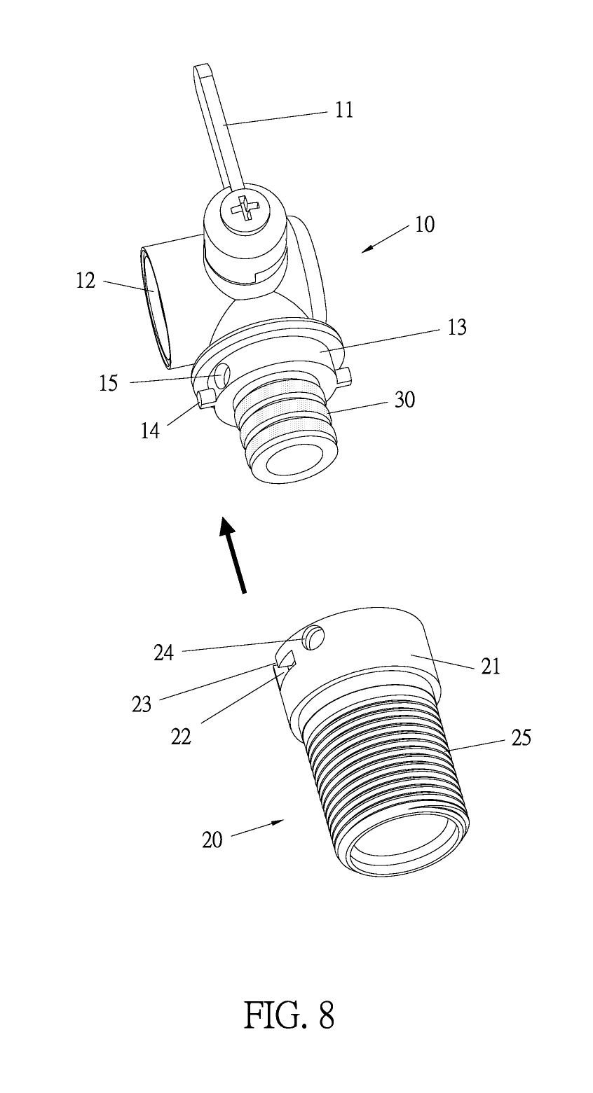

When the body 10 is broken, as illustrated in FIGS. 6-8, the lamination element 40 is unscrewed with the screwing orifice 24 of the threaded tube 20 so as to remove from the connection portion 13 of the body 10, and the two protrusions 14 are rotated in two horizontal sections of the two L-shaped recesses 22 individually and remove the body 10 from the threaded tube 20 via two vertical sections of the two L-shaped recesses 22 and the two openings 23 respectively, thus removing the body 10 from the threaded tube 20 quickly. After the body 10 is replaced, a connection portion 13 and a connector 16 of another body 10 are fitted in a fitting portion 21 and a threaded section 25 of the threaded tube 20, and two protrusions 14 are rotated in the two L-shaped recesses 22 individually so as to connect another body 10 with the threaded tube 20, and the lamination element 40 is screwed in a positioning groove 15 of another body 10 via the screwing orifice 24 of the threaded tube 20 so as to fix the threaded tube 20 and another body 10, thus replacing the body 10 onto the threaded tube 20 easily and avoiding replacement of the threaded tube 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A ball valve device comprising:
a body including an operation handle, a chamber defined in the body and being opened/closed by the operation handle, an outlet formed on a first end of the body and communicating with the chamber, a connection portion formed on a second end of the body and communicating with the chamber, at least one protrusion extending outward from a peripheral side of the connection portion, and a connector connecting and communicating with the connection portion; and
a threaded tube being hollow, and the threaded tube including a fitting portion formed on a first end of the threaded tube which faces the body and fitted on the connection portion of the body, a threaded section arranged on a second end of the threaded tube, and at least one recess corresponding to the at least one protrusion, wherein the connector is fitted in the threaded tube, and the at least one protrusion retains in the at least one recess of the body.

2. The ball valve device as claimed in claim 1, wherein two protrusions extend outward from the body and are opposite to each other, and the fitting portion of the threaded tube includes two recesses retaining with the two protrusions individually.

3. The ball valve device as claimed in claim 1, wherein the body further includes a positioning groove defined on the peripheral side of the connection portion adjacent to the at least one protrusion, the threaded tube further includes a screwing orifice corresponding to the positioning groove of the connection portion, and a lamination element is screwed in the positioning groove of the body via the screwing orifice of the threaded tube so as to fix the threaded tube and the body.

4. The ball valve device as claimed in claim 1, wherein the connector of the body has at least one surrounding trough arranged on an outer wall thereof, and the ball valve device further comprises at least one O ring fitted in the at least one surrounding trough of the body, wherein the at least one O ring abuts against the at least one surrounding trough of the connector and the threaded tube.

5. The ball valve device as claimed in claim 1, wherein the connector of the body has three surrounding troughs arranged on an outer wall thereof, and the ball valve device further comprises three O rings fitted in the three surrounding troughs of the body respectively, wherein the three O rings respectively abut against the three surrounding troughs of the connector and the threaded tube.

6. The ball valve device as claimed in claim 1, wherein the at least one recess of the threaded tube is in an L shape, and the at least one recess has an opening defined on one end thereof and facing the chamber of the body so that the at least one protrusion moves to and horizontally retains in the at least one L-shaped recess via the opening.
